(19) United States
(12) Patent Application Publication
(10) Pub. No.: US 2021/0117644 A1
(43) Pub. Date: Apr. 22, 2021

(54) OPTICAL SENSING SYSTEMS AND DEVICES INCLUDING APERTURES SUPPLANTING PHOTODIODES FOR INCREASED LIGHT THROUGHPUT

(71) Applicant: WILL SEMICONDUCTOR (SHANGHAI) CO, LTD., Shanghai (CN)

(72) Inventor: Joseph Kurth Reynolds, San Jose, CA (US)

(21) Appl. No.: 16/654,285

(22) Filed: Oct. 16, 2019

(51) Int. Cl. G06K 9/00

(52) U.S. Cl. CPC G06K 9/00013

(57) ABSTRACT

Optical sensing systems and devices include a display substrate, a plurality of display elements for displaying visible images, a sensor light source for illuminating a sensing region, wherein the sensor light source is separate from the plurality of display elements, a detector for detecting light from the sensing region, and one or more aperture regions defined in the display between the display elements to facilitate and/or enhance illumination of the sensing region by the sensor light source. The displays may include OLED or LCD displays.

### BACKGROUND

Object imaging is useful in a variety of applications. By way of example, biometric recognition systems image biometric objects for authenticating and/or verifying users of devices incorporating the recognition systems. Biometric imaging provides a reliable, non-intrusive way to verify individual identity for recognition purposes. Various types of sensors may be used for biometric imaging including optical sensors.

### SUMMARY

The present disclosure generally provides optical sensing systems and methods for imaging objects. Various embodiments include one or more in-display aperture regions and one or more under-display light source elements with one or multiple discrete light detector elements positioned on, in or under the display.

According to an embodiment, an optical sensing system is provided that includes a display substrate, a plurality of display elements, e.g., for displaying visible images, a sensor light source for illuminating a sensing region, wherein the sensor light source is separate from the plurality of display elements, a detector for detecting light from the sensing region, and one or more aperture regions defined in the display between the display elements to facilitate and/or enhance illumination of the sensing region by the sensor light source.

According to an embodiment, an optical sensing system is provided that includes a display substrate, a plurality of display elements (e.g., pixel elements) including at least one aperture region in the plurality of display elements, a sensor light source for illuminating a sensing region, wherein the sensor light source is separate from the plurality of display elements, and wherein the sensor light source is disposed under the display substrate and under the plurality of display elements and is located proximal to the at least one aperture region, and a detector for detecting light from the sensing region, e.g., illumination light reflected by an object proximal to the sensing region.

According to another embodiment, an optical display device is provided that includes a display substrate, a plurality of display elements (e.g., pixel elements) including a plurality of aperture regions disposed in the plurality of display elements, a sensor light source including a plurality of light emitting elements for illuminating a sensing region, wherein the sensor light source is separate from the plurality of display elements, and wherein the sensor light source is disposed under the display substrate and under the plurality of display elements and wherein the plurality of light emitting elements are located proximal to corresponding aperture regions, and a detector for detecting light from the sensing region, e.g., illumination light reflected by an object proximal to the sensing region.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE SEVERAL VIEWS OF THE DRAWING(S)

The detailed description is described with reference to the accompanying figures. The use of the same reference numbers in different instances in the description and the figures may indicate similar or identical items.

FIG. 1 is a block diagram of an example of an electronic system that includes a display device and a processing system, according to an embodiment.

FIG. 2 illustrates an example of a display system according to the present disclosure.

FIG. 3 illustrates a plan view of an example of a sensor according to some embodiments, wherein various display pixels (circles) and detector pixels (squares) are located on the same plane or parallel planes, and wherein the sensing surface lies in a plane that is parallel to the detector pixel plane and the display pixel plane.

FIGS. 4A-4B show a series of plan views which illustrate an example of object imaging using a temporal pattern, in accordance with some embodiments.

FIG. 5 illustrates a plan view of a partial image of an object superimposed onto a high contrast region, which is imaged during illumination of a display pixel.

FIG. 6 illustrates a way to provide feedback during imaging of an object using a display according to the present disclosure.

FIG. 7 illustrates a method of obtaining, processing and performing matching of an image of an input object, such as a fingerprint.

FIG. 8 depicts a schematic diagram of an optical system, in accordance with some optical system embodiments.

FIG. 9 shows a plan view of an optical system including LEDs bonded to the back of a display substrate according to an embodiment.

FIGS. 10A-10B illustrate LED size vs. image quality; FIG. 10A illustrates a small LED used to illuminate the sensing region, which may prevent capturing a useful image from the shadowed locations in the sensing region; FIG. 10B illustrates that use of a larger LED may result in a blurring effect as the light arrives on the sensor from different angles.

FIG. 11 illustrates a plan view of an optical system including an aperture region disposed within the display to facilitate light delivery to a sensing region of the optical system, according to an embodiment.

FIG. 12 illustrates a top-down view of an optical system including an aperture region disposed within the display, according to an embodiment.

### DETAILED DESCRIPTION

The following detailed description is exemplary in nature and is not intended to limit the invention or the application and uses of the invention. Furthermore, there is no intention to be bound by any expressed or implied theory presented in the following detailed description or the appended drawings.

Turning to the drawings, and as described in detail herein, embodiments of the disclosure provide methods, devices and systems useful to image, e.g., optically image, an input object such as a fingerprint.

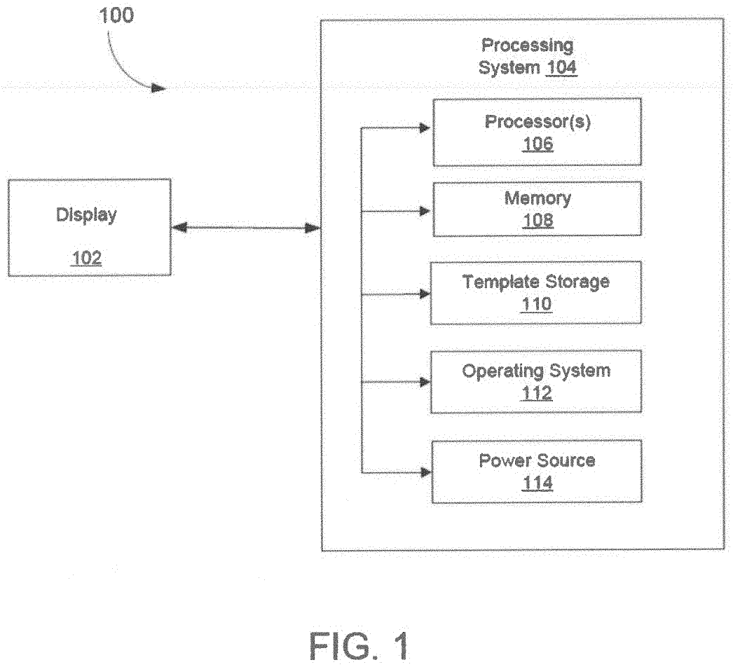

FIG. 1 is a block diagram of an example of an electronic system 100 that includes a display 102 and a processing system 104. The display (or “display device”) 102 may also be used as a sensor for imaging.

By way of example, basic functional components of the electronic device 100 utilized during capturing, storing, and validating a biometric match attempt are illustrated. The processing system 104 may include one or more processors 106, memory 108, template storage 110, operating system (OS) 112 and power source(s) 114. The one or more processors 106, memory 108, template storage 110, and operating system 112 may be connected physically, communicatively, and/or operatively to each other directly or indirectly. The power source(s) 114 may be connected to the various components in processing system 104 to provide electrical power as necessary.

As illustrated, the processing system 104 may include processing circuitry including one or more processors 106 configured to implement functionality and/or process instructions for execution within electronic device 100. For example, one or more processors 106 may execute instructions stored in memory 108 or instructions stored on template storage 110 to normalize an image, reconstruct a composite image, identify, verify, or otherwise match a biometric object, or determine whether a biometric authentication attempt is successful. Memory 108, which may be a non-transitory, computer-readable storage medium, may be configured to store information within electronic device 100 during operation. In some embodiments, memory 108 includes a temporary memory, an area for information not to be maintained when the electronic device 100 is turned off. Examples of such temporary memory include volatile memories such as random access memories (RAM), dynamic random access memories (DRAM), and static random access memories (SRAM). Memory 108 may also maintain program instructions for execution by the processor 106.

Template storage 110 may comprise one or more non-transitory computer-readable storage media. In the context of a fingerprint sensor device or system, the template storage 110 may be configured to store enrollment views or image data for fingerprint images associated with a user's fingerprint, or other enrollment information, such as template identifiers, enrollment graphs containing transformation information between different images or view, etc. More generally, the template storage 110 may store information about an input object. The template storage 110 may further be configured for long-term storage of information. In some examples, the template storage 110 includes non-volatile storage elements. Non-limiting examples of non-volatile storage elements include magnetic hard discs, solid-state drives (SSD), optical discs, floppy discs, flash memories, or forms of electrically programmable memories (EPROM) or electrically erasable and programmable (EEPROM) memories, among others.

The processing system 104 may also host an operating system (OS) 112. The operating system 112 may control operations of the components of the processing system 104. For example, the operating system 112 facilitates the interaction of the processor(s) 106, memory 108, and template storage 110.

According to some embodiments, the one or more processors 106 may implement hardware and/or software to obtain data describing an image of an input object. In some implementations, the one or more processors 106 may also determine whether there is a match between two images, e.g., by aligning two images and compare the aligned images to one another. The one or more processors 106 may also operate to reconstruct a larger image from a series of smaller partial images or sub-images, such as fingerprint images when multiple partial fingerprint images are collected during a biometric process, such as an enrollment or matching process for verification or identification.

The processing system 104 may include one or more power sources 114 to provide power to components of the electronic device 100. Non-limiting examples of power sources 114 include single-use power sources, rechargeable power sources, and/or power sources developed from nickel-cadmium, lithium-ion, or other suitable material as well power cords and/or adapters, which are in turn connected to electrical power. A power source 114 may be external to the processing system 104 and/or electronic device 100.

Display 102 can be implemented as a physical part of the electronic system 100 or can be physically separate from the electronic system 100. As appropriate, display 102 may communicate with parts of the electronic system 100 using various wired and/or wireless interconnection and communication technologies, such as buses and networks. Examples technologies may include Inter-Integrated Circuit (I²C), Serial Peripheral Interface (SPI), PS/2, Universal Serial bus (USB), Bluetooth®, Infrared Data Association (IrDA), and various radio frequency (RF) communication protocols defined by the IEEE 802.11 standard. In some embodiments, display 102 is implemented as an image sensor, e.g., a fingerprint sensor to capture a fingerprint of a user. More generally, the components of display 102, or components integrated in or with the display (e.g., one or more light sources, detectors, etc.) may be implemented to image an object. In accordance with some embodiments, display 102 may use optical sensing for object imaging including imaging biometrics such as fingerprints.

Some non-limiting examples of electronic systems 100 include personal computing devices (e.g., desktop computers, laptop computers, netbook computers, tablets, web browsers, e-book readers, and personal digital assistants (PDAs)), composite input devices (e.g., physical keyboards, joysticks, and key switches), data input devices (e.g., remote controls and mice), data output devices (e.g., display screens and printers), remote terminals, kiosks, video game machines (e.g., video game consoles, portable gaming devices, and the like), communication devices (e.g., cellular phones, such as smart phones), and media devices (e.g., recorders, editors, and players such as televisions, set-top boxes, music players, digital photo frames, and digital cameras).

In some embodiments, the processing system 104 includes display driver circuitry, LED driver circuitry, receiver circuitry or readout circuitry for operating or activating light sources, or for receiving data from or reading out detectors in accordance with some embodiments described elsewhere in this document. For example, the processing system 104 may include one or more display driver integrate circuits (ICs), LED driver ICs, OLED driver ICs, readout ICs, etc.

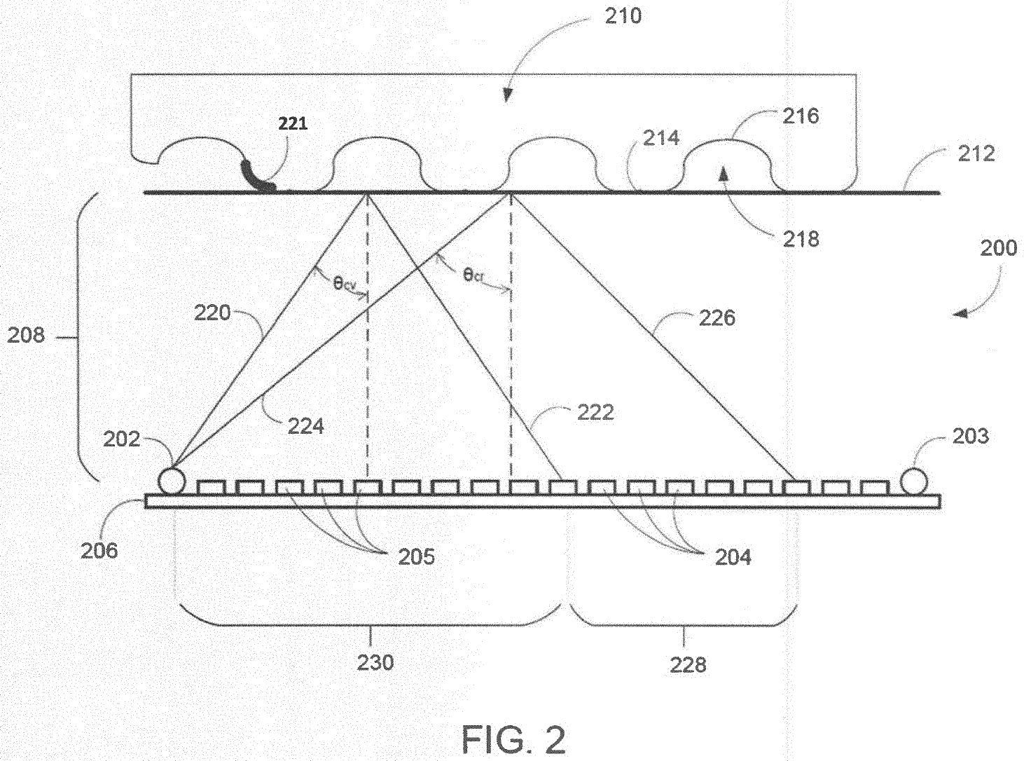

FIG. 2 illustrates an example of an optical display system 200 according to the present disclosure. The optical display system 200 (also referred to as “display 200”) includes one or more light sources (e.g., light sources 202 and 203), photosensors (e.g., detector pixels 204 and 205), a substrate 206, and a cover layer 208. An input object 210 is imaged by the display 200 in accordance with some embodiments. As described above, the display 200 may be a separate device or may be incorporated as part of electronic device 100, including mobile phones, media devices, and any other suitable electronic device.

The light sources 202 and 203 are of a suitable type described below (e.g., OLEDs, micro-LEDs, etc.). In some embodiments, the light sources 202 and 203 may include native display elements (e.g., one or more native OLED pixels/emitters), or dedicated emitters integrated in or with the display (e.g., micro-LEDs integrated in or with an OLED or LCD display). Although only two light sources 202, 203 are shown in FIG. 2, any number and any arrangement of light sources may be used. For example, only one light source may be used, two light sources may be used, or an array of multiple light sources may be used. The light sources 202, 203 may transmit light of the same wavelength or may transmit light of differing wavelengths (e.g., different colors). Moreover, wavelengths other than visible light may be transmitted.

The photosensors or detector pixels 204 and 205 may detect light transmitted from light sources 202, 203. Examples of types of photosensors are CMOS sensors, phototransistors and photodiodes. Thin film transistor-based sensors may also be used in accordance with some embodiments.

Although the light sources 202, 203 and photosensors 204, 205 are depicted as distinct elements, in some embodiments the same type of element may be used to both transmit light and detect transmitted light. For example, the light sources 202, 203 themselves may be reverse-biased to function as detector pixels, using LED, OLED, or another suitable display driver technology. The light sources 202, 203 can be individually reverse biased to function as detector pixels, or may be collectively reverse-biased, e.g., to function as rows or columns of detector pixels. Further, all of the light sources 202, 203 may be addressable in a reverse biased state, or a smaller subset may be addressable in a reverse bias state to minimize the amount of additional routing circuitry that is included, in which case the display 200 may include a special area of fingerprint sensing corresponding to those light sources 202, 203 that can be set to a reverse biased detector state. In addition, although the detector pixels 204, 205 are shown on the same substrate 206 as the light sources 202, 203, the detector pixels 204, 205 can be otherwise arranged within the device, for example, on a different plane from the light sources 202, 203.

The cover layer 208 may include a cover lens, cover glass, or cover sheet, which protects the inner components of the display 200, such as the light sources 202, 203 and the detector pixels 204, 205. The cover layer 208 may be made of any suitable material such as chemically strengthened glass, crystalline materials (e.g., synthetic sapphire), transparent polymeric materials, and the like. The cover layer 208 may also include one or more additional layers associated with display and/or touch screen functionality, such as capacitive touch screen functionality. The cover layer 208 may be transparent thereby allowing light from light sources 202, 203 and the native display elements (e.g., native OLED emitters) to be transmitted and observed outside of the display 200. A top surface of the cover layer 208 forms a sensing surface or input surface 212, which provides a contact area for the input object 210.

The input object 210 is an object to be imaged and may include a biometric object such as a fingerprint. The input object 210 may have various characteristics, for example, ridges 214 and valleys 216. Due to their protruding nature, the ridges 214 contact the sensing surface 212 of the cover layer 208. In contrast, the valleys 216 generally do not contact the sensing surface 212 and instead form a gap 218 between the input object 210 and the sensing surface 212. The input object 210 may have other characteristics 221, such as moisture, stain, or ink, that do not create significant structural differences in portions of the input object 210, but which may affect its optical properties.

The light sources 202, 203 transmit beams of light within the cover layer 208 and the transmitted light becomes incident on the sensing surface 212 of the cover layer 208 at various angles. Depending on the angles, some of the transmitted light is reflected and some of the transmitted light is refracted. However, for cases where no fingerprint ridge is present on the sensing surface 212, light beams which arrive at the sensing surface 212 at an angle exceeding a critical angle θc undergo total internal reflection, i.e., all light from the transmitted beam exceeding the critical angle is reflected at the sensing surface 212.

As will be appreciated, since the medium above the sensing surface 212 may vary, the critical angle at various points along the sensing surface 212 may likewise vary. For example, the ridges 214 of the input object 210 and gaps 218 formed within the valleys 216 of the input object 210 may have different indices of refraction. As a result, different critical angles may exist at the boundaries between the sensing surface 212 and ridges 214 as compared to the boundaries formed by the gaps 218 and the sensing surface 212. These differences are illustratively shown in FIG. 2. Line 220 represents a beam of light transmitted from the light source 202 at the critical angle (θcv) for a gap 218 and sensing surface 212 boundary, and line 222 represents the corresponding reflected beam. Line 224 represents a beam of light transmitted at the critical angle (θcr) for a ridge 214 and sensing surface 212 boundary, and line 226 represents a corresponding reflected beam. Relative to light source 202, region 228 depicts an area on the substrate 206 that is bounded by reflected light resulting from light beams transmitted at the critical angles θcv and θcr, or in other words is bounded by reflected beams 222 and 226.

In accordance with some embodiments, detector pixels 204 falling within region 228 are used to detect reflected light to image part of input object 210 when light source 202 is illuminated. With respect to the detection of ridges and valleys, region 228 is an area of relatively high contrast. The relative high contrast occurs because light reflected from the sensing surface 212 in contact with valleys 216 (e.g., air) undergoes total internal reflection whereas light reflected from the sensing surface 212 in contact with the input object 210 (e.g., skin) does not. Thus, light beams transmitted from light source 202 which have an angle of incidence at the sensing surface falling between θcv and θcr are reflected and reach detector pixels 204 falling within region 228.

In accordance with another aspect of the disclosure, detector pixels 205 falling within region 230 (relative to light source 202) may also be used to image the input object 210. In particular, transmitted beams from light source 202, which become incident on the sensing surface 212 with angles smaller than both critical angle of ridge (θcr) and critical angle of valley (θcv) result in reflected beams falling within region 230. Due to scattering, the contrast of reflected beams falling within region 230 from ridges 214 and valleys 216 may be less than the contrast of reflected beams falling within high contrast region 228. However, depending on factors such as the sensitivity of the detector pixels 204, 205 and resolution requirements, region 230 may still be suitable for sensing ridges 214 and valleys 216 on the input object 210. Moreover, region 230 may be suitable for detecting non-structural optical variations in the input object 210 such as moisture or stains or ink 221.

It will be appreciated that the reflected light beams detected in region 228 may provide a magnified view of a partial image of the input object 210 due to the angles of reflection. The amount of magnification depends at least in part upon the distance between the light source 202 and the sensing surface 212 as well as the distance between the detectors 204 and the sensing surface 212. In some implementations, these distances may be defined relative to the normal of these surfaces or planes (e.g., relative to a normal of the sensing surface or relative to a plane containing the light source or detectors). For example, if the light source 202 and the detector pixels 204 are coplanar, then the distance between the light source 202 and the sensing surface 212 may be equivalent to the distance between the detectors 204 and the sensing surface 212. In such a case, an image or partial image of the input object 210 may undergo a two-times magnification (2×) based on a single internal reflection from the sensing surface 212 reaching the detector pixels 204 in region 228.

The critical angles θ_{cr} and θ_{cv} resulting from ridges 214 and gaps 218 at the sensing surface 212 are dependent at least in part on the properties of the medium in contact with the boundary formed at the sensing surface 212, which may be affected by a condition of the input object 210. For example, a dry finger in contact with the sensing surface 212 may result in a skin to air variation across the sensing surface 212 corresponding to fingerprint ridges and valleys, respectively. However, a wet finger in contact with the sensing surface 212 may result in a skin to water or other liquid variation across the sensing surface 212. Thus, the critical angles of a wet finger may be different from the critical angles formed by the same finger in a dry condition. Thus, in accordance with the disclosure, the intensity of light received at the detector pixels 204, 205 can be used to determine the relative critical angles and/or whether the object is wet or dry, and perform a mitigating action such as processing the image differently, providing feedback to a user, and/or adjust the detector pixels or sensor operation used for capturing the image of the input object. A notification may be generated to prompt correction of an undesirable input object condition. For example, if a wet finger is detected, a message may be displayed or an indicator light may be lit to prompt the user to dry the finger before imaging.

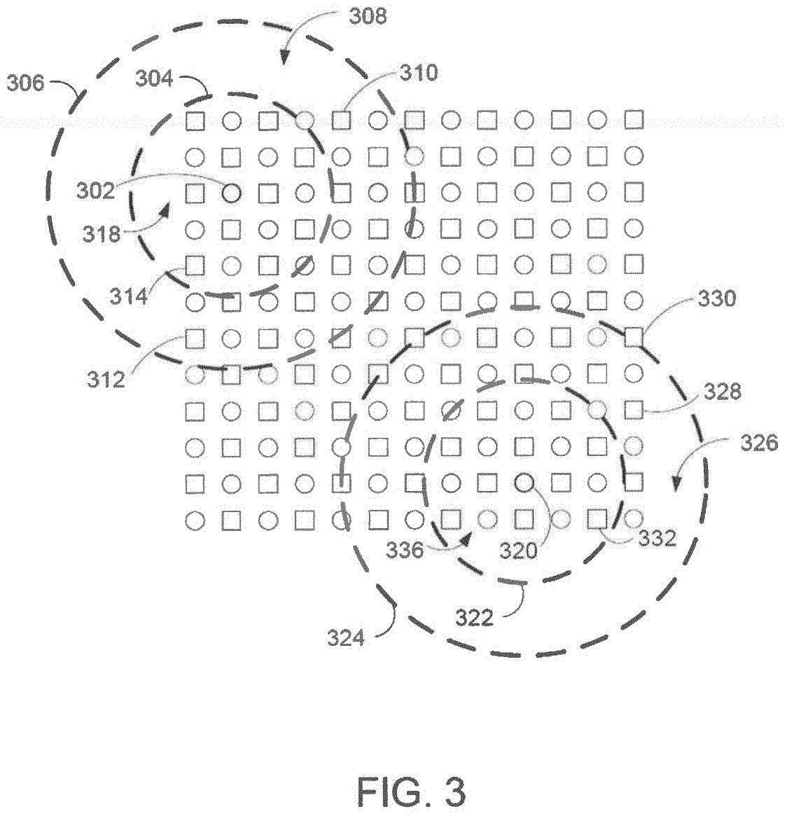

FIG. 3 illustrates a plan view of an example of a sensor according to some embodiments, wherein various display elements or pixels (circles) and detector pixels (squares) are located on the same plane or parallel planes, and wherein the sensing surface lies in a plane that is parallel to the detector pixel plane and the display pixel plane. In the example, a light source corresponding to display pixel 302 is illuminated for imaging a portion of the input object 210 (FIG. 2). Concentric circles 304 and 306 illustrate boundaries of a high contrast region 308, which as described above depend at least in part on factors such as the dimensions of the display as well as the critical angles θ_{cr} and θ_{cv}.

In certain embodiments, when the light source corresponding to display pixel 302 is illuminated, detector pixels falling within the high contrast region 308, such as detector pixels 310 and 312 may be used to detect reflected light from the display pixel 302 to image a portion of the input object. In other embodiments, or in combination with the collection of data from region 308, detector pixels, such as detector pixels 314 falling within region 318 may be used.

Also shown in FIG. 3 is a second light source corresponding to a second display pixel 320. Concentric circles 322 and 324 illustrate boundaries of a second high contrast region 326, which corresponds to display pixel 320. Detector pixels within region 326, such as detector pixels 328 and 330, may be used to collect data corresponding to the object to be imaged. In other embodiments, or in combination with the collection of data from region 326, detector pixels, such as detector pixel 332 falling within region 336 may be used. In some implementations, an entirety of the detector array is read out and portions of the image falling outside of the region of interest are filtered out or discarded. In other implementations, the detector array is selectively read out or scanned to capture image data from only the region of interest in accordance with the currently active light source.

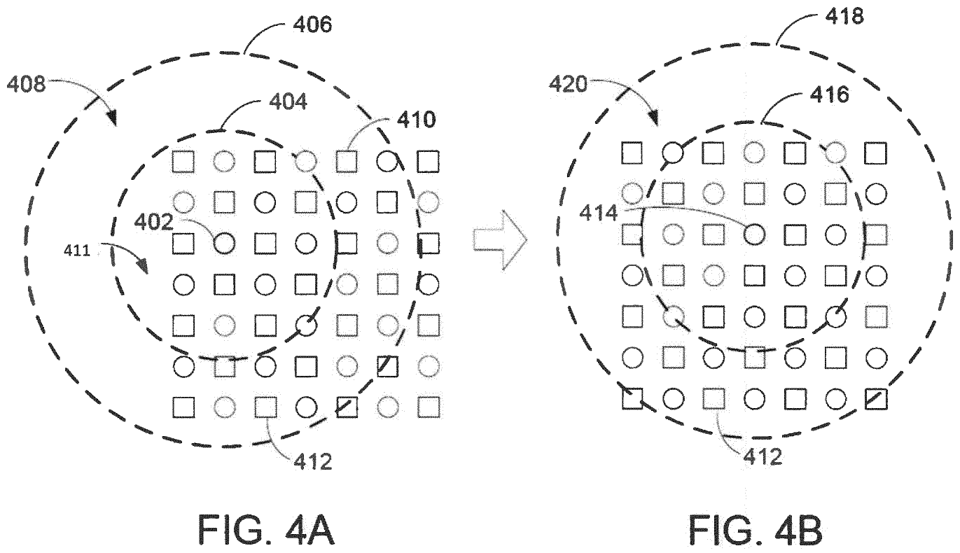

In the example of FIG. 3, high contrast region 308 and high contrast region 326 are non-overlapping. It will be understood, however, that regions 308 and 326 may overlap. In the case of overlapping high contrast regions, light sources 302 and 320 may be illuminated at different times, as discussed in connection with FIGS. 4A-4B below. Alternatively, provisions may be made to distinguish the light transmitted from light source 302 as compared to the light transmitted from light source 320 in which case light sources 302 and 320 may be simultaneously illuminated while data is collected within their respective high contrast regions. When display pixels 302 and 320 are simultaneously illuminated as part of object imaging, FIG. 3 provides an example of object imaging using a spatial pattern.

It will be understood that FIG. 3 illustrates only the illumination of two light sources and each light source includes corresponding detection regions within which data is collected for partial images of the input object. In operation, any number of light sources may be illuminated to capture enough partial images to make up a larger image, or complete image of the object. In some implementations, one light source may be sufficient. It will also be understood that various display elements or pixels may be independently used for displaying visual information simultaneously while selected light sources (which may be part of or separate from the display) are illuminated for object imaging. For example, a light source may be used that is significantly brighter than the light from surrounding display light from display images, allowing the optical sensor signal to be strong enough to be discriminated from a noisy background caused by display. Alternatively, the display pixels may be locally turned off or dimmed in a region surrounding the currently active sensor light source during sensing.

FIGS. 4A-4B show a series of plan views which illustrate an example of object imaging using a temporal pattern, in accordance with some embodiments. In FIG. 4A, a display pixel is used as a light source. When light source 402 is illuminated, concentric circles 404 and 406 identify the boundaries of high contrast area 408. In this configuration, detector pixels within the high contrast area 408, such as detector pixels 410 and 412, may be used to collect data corresponding to ridges and valleys, or other surface features, from input object 210 to be imaged. Alternatively, or in combination with the foregoing, detector pixels within region 411, which is radially inward from boundary 404, may be used. In some implementations, other detector pixels outside the region 406 may be used.

FIG. 4B represents the same set of display pixels and detectors pixels as FIG. 4A, but at a different time. Light source 414 is illuminated. As will be noted, the concentric circles 416 and 418 identifying the boundaries of corresponding high contrast region 420 have moved relative to the high contrast region 408 of FIG. 4A. Thus, the subset of detector pixels falling in the high contrast area have changed, although some pixels may fall with both high contrast areas 408 and 420 such as detector pixel 412.

In the example of FIGS. 4A and 4B, high contrast regions 408 and 420 overlap. However, illumination of the light sources 402 and 414 are temporally spaced. For example, light source 402 is illuminated or activated. After the data is collected from within region 408, light source 402 is turned off or deactivated. Light source 414 is then illuminated or activated and data is collected from within region 420. After data is collected from within region 420, light source 414 is turned off. This process continues using as many display pixels, and in any sequence, as desired to capture enough partial images to form a larger or complete image or representation of the input object as desired. As previously described, this disclosure also contemplates the simultaneous illumination of multiple display pixels having non-overlapping high contrast areas as well as simultaneous illumination of multiple display pixels having overlapping high contrast areas provided, for example, that the reflected light received from the different illumination pixels can be resolved or determined.

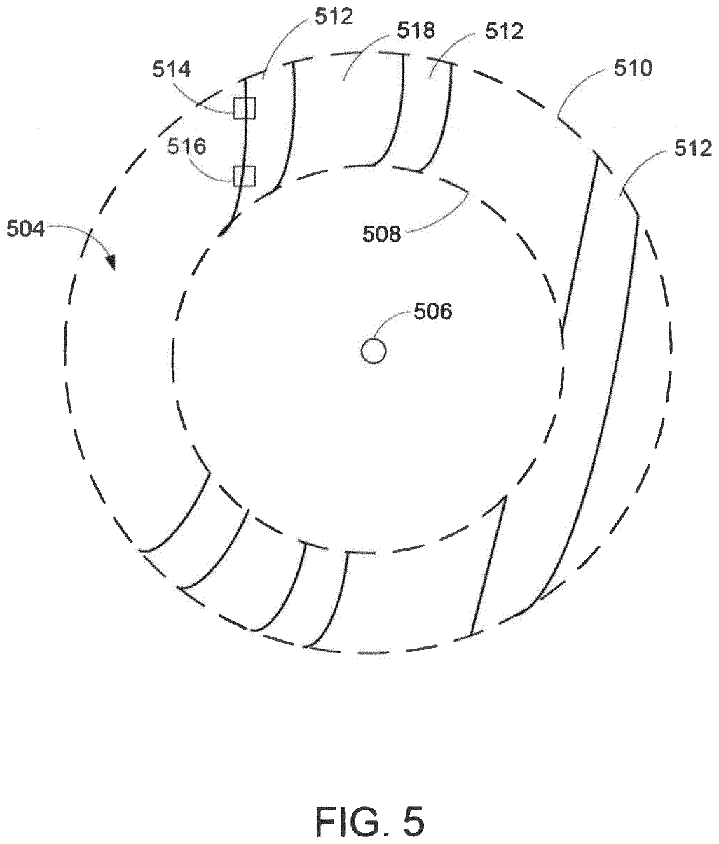

FIG. 5 illustrates a plan view of a partial image of an object superimposed onto a high contrast region 504, which is imaged during illumination of display pixel 506. Concentric circles 508 and 510 show the boundaries of the high contrast region 504. Portions 512 correspond to ridges of the input object. Other areas within the high contrast region 504 correspond to valleys 518 of the input object. As previously described, due to the angles of reflection undergone by light transmitted by display pixel 506, the ridges and the valleys detected in the high contrast region 504 may be magnified as compared the actual ridges and valleys on the object. The amount of magnification may depend on the geometry of the display, including the distance between the display pixels, detector pixels, and the sensing region. Moreover, detector pixels further away from the display pixel 506, e.g., detector pixel 514, may receive lower intensity reflected light as compared to detector pixels closer to the display pixel, e.g., detector pixel 516 because the intensity of light decreases in relation to the distance it travels in the various display layers.

In some applications, image data from various partial images obtained during patterned illumination (e.g., sequential or simultaneous illumination of display pixels) of the individual display pixels is combined into composite image data of the input object. The partial image data may be aligned based on known spatial relationships between the illumination sources in the pattern. By way of example, the partial image data may be combined by stitching together the partial images into a larger image, or by generating a map that relates the image data from the various partial images according to their relative alignments. Demagnification of the images may be useful prior to such piecing together or mapping. In addition, it may be useful to apply a weighting function to the image data to account for the different intensities of light received at detector pixels having different distances from the display pixels. In some applications, if pixels inside of region 508 are used, the resulting data from the various partial images may be deconvolved to reconstruct the larger image. Alternatively, the data inside of this region may convey sufficient information for some applications, so that no deconvolution is used. U.S. patent application Ser. No. 16/006,639, filed Jun. 12, 2018, and titled “Systems And Methods For Optical Sensing Using Point-Based Illumination,” which is hereby incorporated by reference, discusses image stitching and construction of images, for example at FIGS. 22A, 22B, 22C, 26 and 27, and their related description.

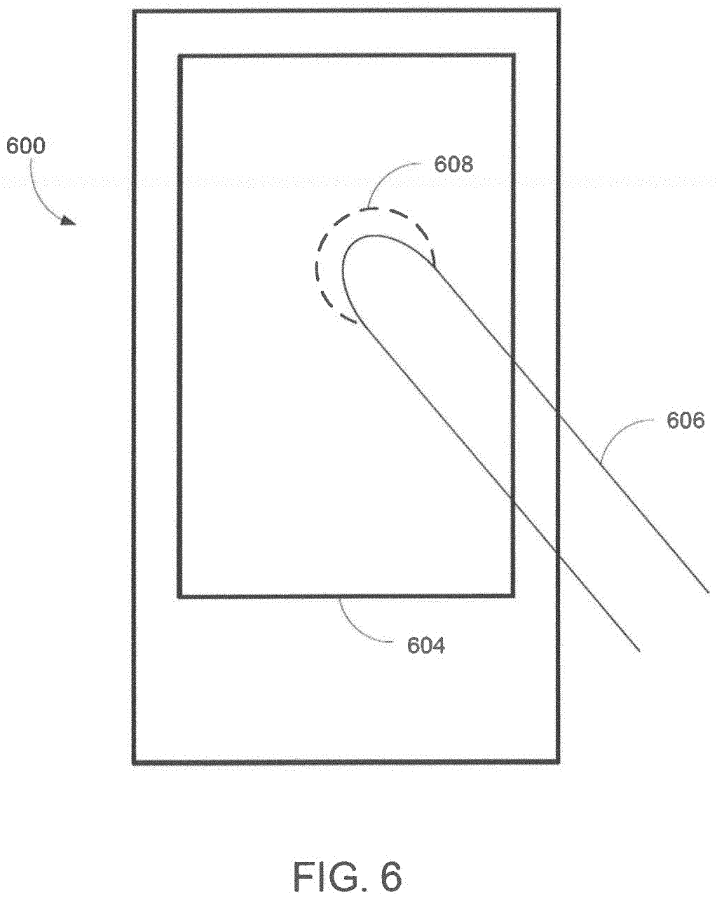

FIG. 6 illustrates a way to provide feedback during imaging of an object using a display according to the present disclosure. Such feedback may be used, for example, to provide feedback to a user during acquisition of a fingerprint image in an enrollment and/or authentication process.

As shown, the device 600 includes an active display area 604. The active display area 604 may encompass a portion of a surface of the device 600 as shown, or it may encompass the entire device surface or multiple portions of the device surface. Also, the sensing surface or input surface may encompass a portion of the active display area 604, or the sensing surface may encompass the entire active display area 604 or multiple portions of the active display area 604. An object 606, such as a finger, is placed over (e.g., proximal to or in contact with) the active display area 604. One or more light sources (not shown) underneath the object 606 are illuminated according to a pattern to image part or all of the object 606 in accordance with the description herein. During or after imaging of the object 606, display pixels or other light sources at or about the perimeter of the object 606 may be illuminated to provide a visually perceptible border 608. The displayed border 608 may change in appearance to signify status. For example, while the object 606 is being imaged and/or during an authentication period, the border could be a first color (e.g., yellow). Once the imaging and authentication is completed, the color could change to a second color (e.g., green) if the authentication is successful or a third color (e.g., red) if the authentication is unsuccessful. It will be appreciated that changes in color provide one example of how the border 608 may be altered to signal status to the user. Other changes in the appearance of the border, such as a change from dashed line to a solid line, or an overall change in the shape of the border could be employed as well.

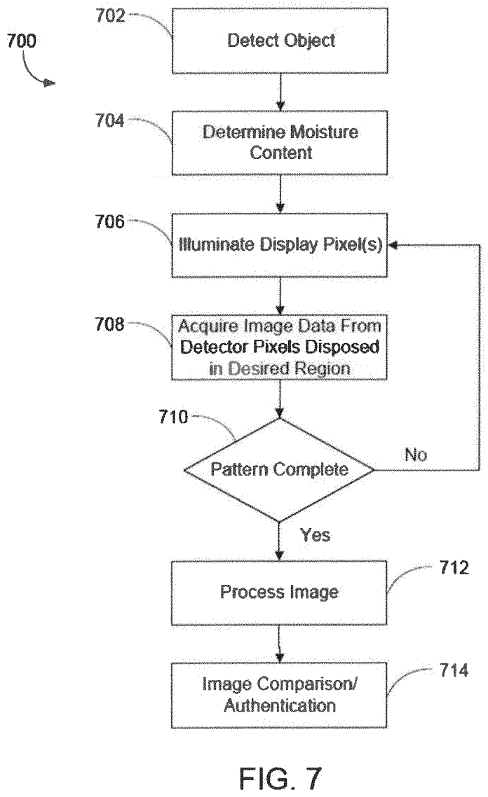

FIG. 7 illustrates an exemplary method 700 of obtaining, processing and performing matching of an image of an input object, such as a fingerprint. By way of example, matching may be used for biometric authentication or biometric identification. It will be appreciated that the steps and sequence of steps are by way of example only. Steps may be eliminated or the sequence modified without departing from the present disclosure.

In step 702, the presence of an input object proximal to or in contact with the sensing surface of the display is detected. Such detection may occur, for example, as the result of detection of changes of intensity in light received at detector pixels in the display. Alternatively, presence of the input object may be detected via capacitive sensing or other conventional techniques using a touch screen for example.

In step 704, moisture content of the input object to be imaged is determined. The moisture content can be determined, for example, by illuminating display pixels to determine the inner boundary of the high contrast area. By comparing the determined inner boundary of the high contrast to an expected boundary for a dry object, the relative moisture content can be estimated. The moisture content can be used for various purposes. For example, the detected moisture content can be used as a metric of expected image quality. The detected moisture content may also be used to establish the boundaries of high contrast and, therefore, used to establish which detector pixels will be used to collect data when a given light source is illuminated as part of the imaging process. The detected moisture content may also be used to notify the user that a suitable image cannot be obtained. The user may then be instructed to dry the object (e.g., finger) and initiate another imaging attempt.

In step 706, one or more light sources (e.g., display pixels, separate LEDs, etc.) are illuminated to image the input object. The light sources to be illuminated and sequence of illumination depend on the illumination pattern used. If a spatial pattern is used, multiple spatially separated light sources are simultaneously illuminated. If a temporal pattern is used, different light sources, or different clusters of light sources that are collectively operated as a point source, are illuminated at different times. As previously described, the pattern used for imaging may include a combination of temporal and spatial patterns. For example, a first set of display pixels may be illuminated first where the corresponding high contrast areas are non-overlapping. This may then be followed by a second set of distinct display pixels being illuminated, which likewise provide non-intersecting high contrast regions and so on. The display pixels illuminated and sequence of illumination may be guided by a touch position detected by capacitive sensor or touch screen, for example.

It is further contemplated that multiple display pixels may be illuminated even though they provide overlapping high contrast areas. In such an arrangement, the display pixels transmit light of different wavelengths (e.g., colors), which can be separately detected to resolve different partial images of the object. Alternatively, techniques such as code division multiplexing (CDM) may be used to transmit the light. In such an arrangement, the collected data may be deconvolved to resolve the different subparts of the fingerprint. Other methods to distinguish between light transmitted from different display pixels may be used provided that light transmitted from different display pixels can be detected and distinguished.

In step 708, image data is obtained from appropriate detector pixels. The appropriate detector pixels will, for example, be the detector pixels in the corresponding high contrast region(s) for the display pixel(s) illuminated. However, as previously described, a region inside of the high contrast region may be used. Further, in some implementations, the entire detector array is read out or scanned and then the undesired pixel region can be filtered out with image processing.

In step 710, a determination is made as to whether the illumination pattern is complete. The pattern is complete when data for all of the partial images that will make up the entirety of a desired image of the object is collected. If the pattern is not complete, the process returns to step 706. In step 706, the next light source or set of light sources is illuminated.

In step 712, the collected data for the various partial images undergo processing. By way of example, the processing may include demagnification of the image data and/or normalization or the application of weighting factors to the image data to account for the different intensities of light detected at detector pixels further away from the light sources. The processing may further include combining the data for the various partial images into a complete image or creating a template that relates the partial images to one another even though they are kept separate. The image data from the various partial images may be combined according to the known geometric relationships between the pixels in the pattern. The image data may also be combined based on other parameters, such as the thickness of the cover layer, which provides additional information about the light beam paths from the illumination and detector pixels to the sensing surface to resolve physical transformations between the partial images. The thickness of the cover layer may be pre-defined or may be computed at image capture time based on the location of the inner boundary of the high contrast region. For example, the location of the inner boundary may be closer or further away from the illuminated display pixel for thinner or thicker cover layers, respectively.

In step 714, the image data may be compared to previously stored images of the object. For example, an image of a fingerprint taken during an authentication attempt may be compared to previously stored enrollment views of the fingerprint. If a match is detected, the user is authenticated. If a match is not detected, authentication may be denied. As another example, an image of a fingerprint taken during a control input may be compared to previously stored enrollment views of the fingerprint to identify which finger provided the input. If a match is detected to a specific finger, a finger specific display response or other device operation may then be initiated based on the identified finger.

As described in connection with FIG. 6, the user may be provided with feedback during the process described in connection with FIG. 7. For example, a colored border may be provided around the user's finger during imaging and/or while the authentication process is underway. Once those processes are complete, the color of the border may change to signify completion of imaging and the results of the authentication. For example, a green border signifies authentication is successful whereas a red border signifies that the authentication failed.

After image processing, the collected data for the object may be stored for later use, e.g., in memory 108 or template storage 110.

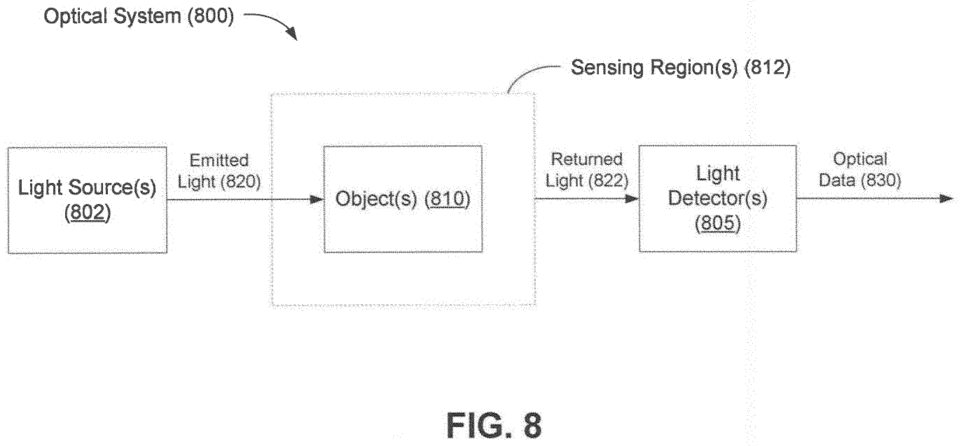

FIG. 8 depicts a schematic diagram of an optical system 800, in accordance with some optical system embodiments. The optical system 800 is configured to optically detect one or more objects 810 and includes one or more light sources 802, one or more sensing regions 812, and one or more light detectors (or “optical detectors”) 805. When operated, the light source(s) 802 emits emitted light 820 towards the sensing region(s) 812, and the emitted light 820 interacts with the object(s) 810 when the object(s) 810 is disposed in the sensing region(s) 812. The light detector(s) 805 detects returned light 822 returning from the sensing region(s) 812 and converts the returned light 822 into optical data 830.

The sensing region(s) 812 encompasses one or more spaces or areas in which the optical system 800 is capable of detecting the object(s) 810 and capturing sufficient information associated with the object(s) 810 that is of interest to the optical system 800. The sensing region(s) 812 is optically coupled to both the light source(s) 802 and the light detector(s) 805, thereby providing one or more illumination optical paths for the emitted light 820 to reach the sensing region(s) 812 from the light source(s) 802 and one or more return optical path(s) for the returned light 822 to reach the light detector(s) 805 from the sensing region(s) 812. The illumination optical path(s) and the detection optical path(s) may be physically separate or may overlap, in whole or in part. In some implementations of the optical system 800, the sensing region(s) 812 includes a three-dimensional space within a suitable depth or range of the light source(s) 802 and the optical detector(s) 805 for depth imaging or proximity sensing. In some implementations, the sensing region(s) 812 includes a sensing surface (e.g., a sensor platen) having a two dimensional area for receiving contact of the object(s) 810 for contact imaging or touch sensing. In some implementations, the sensing region(s) 812 may encompasses a space or area that extends in one or more directions until a signal to noise ratio (SNR) or a physical constraint of the optical system 800 prevents sufficiently accurate detection of the object(s) 810.

The light source(s) 802 includes one or more light emitters (e.g., one or more light emitting devices or materials) configured to illuminate the sensing region(s) 812 for object detection. In some implementations of the optical system 800, the light source(s) 802 includes one or more light emitting diodes (LEDs), lasers, or other electroluminescent devices, which may include organic or inorganic material and which may be electronically controlled or operated. In some implementations, the light source(s) 802 includes a plurality of light sources, which may be arranged in a regular array or irregular pattern and which may be physically located together or spatially segregated in two or more separate locations. The light source(s) 802 may emit light in a narrow band, a broad band, or multiple different bands, which may have one or more wavelengths in the visible or invisible spectrum, and the light source(s) 802 may emit polarized or unpolarized light. In some implementations, the light source(s) 802 includes one or more dedicated light emitters, which are used only for illuminating the sensing region(s) 812 for object detection. In some implementations, the light source(s) 802 includes one more light emitters associated with one or more other functions of an electronic system, such as emitters or display elements used for displaying visual information or images to a user.

The light detector(s) 805 includes one or more light sensitive devices or materials configured to detect light from the sensing region(s) 812 for object detection. In some implementations of the 800, the light detector(s) 805 includes one or more photodiodes (PDs), charge coupled devices (CCDs), phototransistors, photoresistors, or other photosensors, which may include organic or inorganic material and which may be electronically measured or operated. In some implementations, the light detector(s) 805 includes a plurality of light sensitive components, which may be arranged in a regular array or irregular pattern and may be physically located together or spatially segregated in two or more separate locations. In some implementations, the light detector(s) 802 includes one or more image sensors, which may be formed using a complementary metal-oxide-semiconductor (CMOS), a thin film transistor (TFT), or charge-coupled device (CCD) process. The light detector(s) 805 may detect light in a narrow band, a broad band, or multiple different bands, which may have one or more wavelengths in the visible or invisible spectrum. The light detector(s) 805 may be sensitive to all or a portion of the band(s) of light emitted by the light source(s) 802.

The object(s) 810 includes one or more animate or inanimate objects that provide information that is of interest to the optical system 800. In some implementations of the optical system 800, the object(s) 810 includes one or more persons, fingers, eyes, faces, hands, or styluses. When the object(s) 810 is positioned in the sensing region(s) 812, all or a portion of the emitted light 820 interacts with the object(s) 810, and all or a portion of the emitted light 820 returns to the light detector(s) 805 as returned light 822. The returned light 822 contains effects corresponding to the interaction of the emitted light 820 with the object(s) 810. In some implementations of the optical system 800, when the emitted light 820 interacts with the object(s) 810 it is reflected, refracted, absorbed, or scattered by the object(s) 810. Further, in some implementations the light detector(s) 805 detects returned light 822 that contains light reflected, refracted, or scattered by the object(s) 810 or one or more surfaces of the sensing region(s) 812, and the returned light 822 is indicative of effects corresponding to the reflection, refraction, absorption, or scattering of the light by the 810. In some implementations, the light detector 805 also detects other light, such as ambient light, environmental light, or background noise.

The light detector(s) 805 converts all or a portion of the detected light into optical data 830 containing information regarding the object(s) 810, and corresponding to the effects of the interaction of the emitted light 820 with the object(s) 810. In some implementations, the optical data 830 includes one or more images, image data, spectral response data, biometric data, or positional data. The optical data 830 may be provided to one or more processing components for further downstream processing or storage.

Components of the optical system 800 may be contained in the same physical assembly or may be physically separate. For example, in some implementations of the optical system 800, the light source(s) 802 and the optical detector(s) 805, or subcomponents thereof, are contained in the same semiconductor package or same device housing. In some implementations, the light source(s) 802 and the light detector(s) 805, or subcomponents thereof, are contained in two or more separate packages or device housings. Some components of the optical system 800 may or may not be included as part of any physical or structural assembly of the optical system 800. For example, in some implementations, the sensing region(s) 812 includes a structural sensing surface included with a physical assembly of the optical system 800. In some implementations, the sensing region(s) 812 includes an environmental space associated with the optical system 800 during its operation, which may be determined by the design or configuration of the optical system 800 and may encompass different spaces over different instances of operation of the optical system 800. In some implementations, the object(s) 810 is provided by one or more users or environments during operation of the optical system 800, which may include different users or environments over different instances of operation of the optical system 800.

The optical system 800 may include one or more additional components not illustrated for simplicity. For example, in some implementations of the optical system 800, the optical system 800 includes one or more additional optics or optical components (not pictured) included to act on the light in the optical system 800. The optical system 800 may include one or more light guides, lenses, mirrors, refractive surfaces, diffractive elements, filters, polarizers, spectral filters, collimators, pinholes, or light absorbing layers, which may be included in the illumination optical path(s) or return optical path(s) and which may be used to modify or direct the light as appropriate for detection of the object(s) 810.

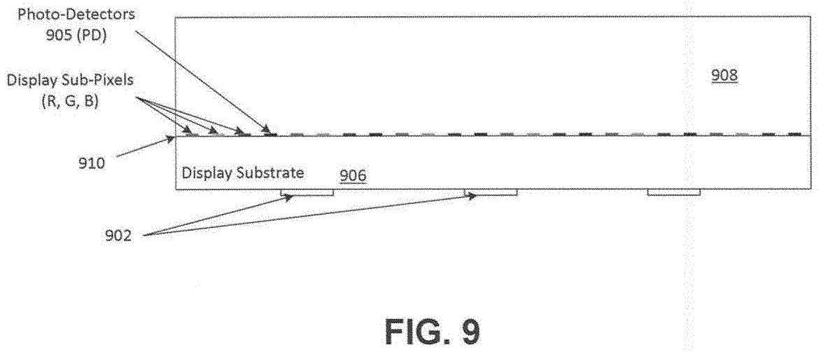

FIG. 9 depicts a schematic diagram of a display 900 in accordance with certain display device or sensing system embodiments. The display 900 includes a display substrate 906 (which may include one or more material layers), display pixel circuitry 910, and a cover layer or cover 908.

The display 900 is an electronic visual display device for presenting images, video, or text to one or more viewers or users. The display 900 includes display pixel circuitry 910 (e.g., one or more electrodes, conductive lines, transistors, or the like) disposed fully or partially over the display substrate 906 for operating one or more display elements or display pixels in the display 900. The display pixel circuitry 910 may be disposed over the display substrate 906, directly on a surface of the display substrate 906, or on one or more intervening layers that are disposed on the display substrate 906. The cover 908 includes one or more layers (e.g., one or more passivation layers, planarization layers, protective cover sheets, or the like) disposed over the display substrate 906 and disposed over the display pixel circuitry 910. In some embodiments of the display 900, the display 900 forms a flat, curved, transparent, semitransparent, or opaque display panel. In some embodiments, the display 900 includes a plurality of layers arranged in a display stack. The display stack may include all layers making up a display panel or any plural subset of stacked layers in a display panel.

The display 900 may utilize a suitable technology for displaying two or three-dimensional visual information, such as organic light emitting diode (OLED) technology, micro-LED technology, liquid crystal display (LCD) technology, plasma technology, electroluminescent display (ELD) technology, or the like. In some embodiments of the display 900, the display pixel circuitry 910 includes an active matrix or passive matrix backplane. In some embodiments, the display 900 is an emissive or non-emissive display. In some emissive embodiments of the display 900, the display pixel circuitry 910 controls or operates pixel values of a plurality of light emitting display pixels (e.g., subpixels R, G, B), and the display pixels are top emitting or bottom emitting. In some non-emissive embodiments of the display 900, the display pixel circuitry 910 controls or operates pixel values of a plurality of transmissive or reflective display pixels. In some embodiments, the display 900 presents or displays visible images that are viewable from one or more sides of the display that may be above the cover side, below the substrate.

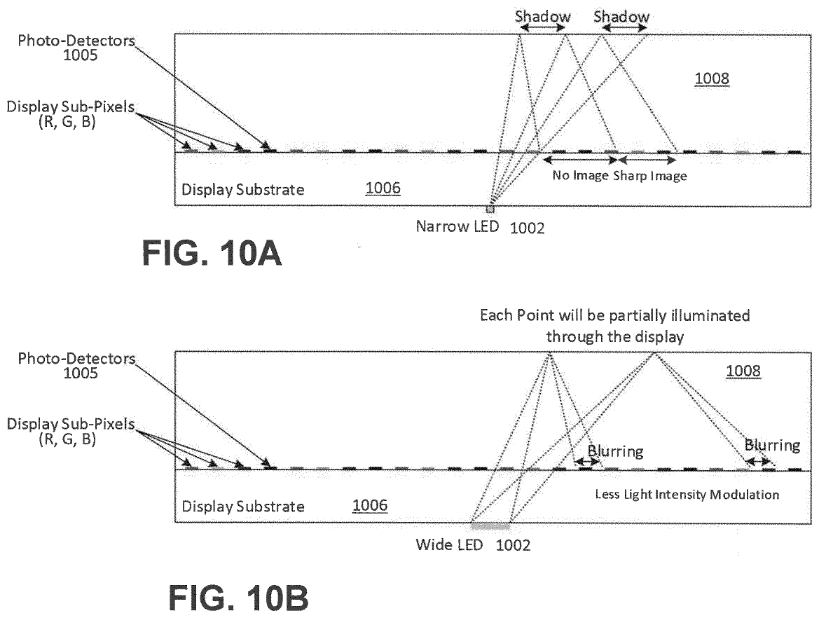

With reference to FIGS. 9, 10A and 10B, certain embodiments provide an illumination source for an optical sensor, e.g., optical fingerprint sensor, using point source illumination (or approximated point source illumination). In certain embodiments, a display device may include a light source, e.g., including one or more LEDs 902, 1002, bonded on the back of a display substrate 906, 1006 or one or more LEDs bonded to a separate substrate that is be bonded/adhered to the substrate 906, 1006. In some embodiments, these techniques may be implemented in an OLED (with a transparent substrate) or LCD display.

In-display optical fingerprint sensor embodiments based on point source illumination (e.g., using light sources 902, 1002) provide a higher signal-to-noise ratio (SNR) as compared with collimator-based optical fingerprint sensors (FPSs) because a collimating filter (collimator) does not need to be used and bright axillary sources (e.g., light sources 902, 1002) with intensities considerably higher than the display can be used to directly illuminate the finger (transmission through display can be 5-10% while a 1/10 aspect ratio collimator has a transmission of 0.5%, as an example). Moreover, collimator-based optical FPSs are difficult to implement in displays other than OLED displays, while the in-display optical FPS based on point source illumination can be implemented on other displays such as LCD displays.

In the embodiments shown and described with reference to FIGS. 9, 10A and 10B, a detector including an array of photodetectors 905, 1005 (“PD”) is integrated in the display, and one or several point sources are used to illuminate the object, e.g., finger. The light from a point source reflected back from the finger/cover-glass interface or finger input surface and a magnified image (polar magnified around the point source) of the interface is captured on the photodetector array.

As shown, one or several LEDs 1002 can be bonded to the back of the display substrate 1006 as shown in FIG. 10B. Alternately, the one or more LEDs 1002 can be bonded to a separate substrate which may be bonded to the back of the display substrate 1006 as shown in FIG. 10A, e.g., using an optically clear adhesive (OCA).

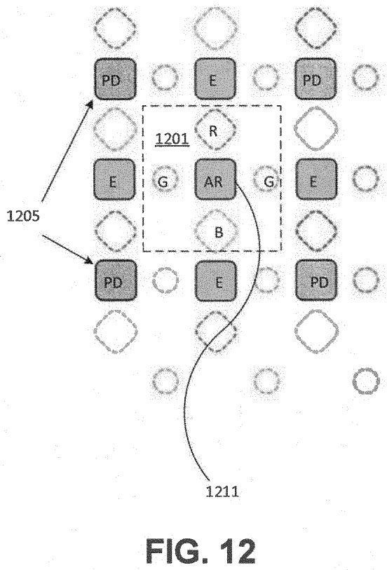

For an LED placed under a backplane, for example, the light that illuminates the sensing region (e.g., finger in sensing region) may be blocked by TFTs, metal lines, OLED pixel elements, a black mask (in case of LCD), etc. Therefore, for example, if a small LED is used to illuminate the finger, parts of the finger may not be illuminated, which may prevent capturing a useful image from the shadowed location. On the other hand, a larger LED may result in a blurring effect as the light arrives on the sensor from different angles. This has been schematically illustrated in FIGS. 10A and 10B. In one embodiment, a maximum LED size or maximum LED cluster size allowed is selected. For example, a rough estimate for maximum LED size can be the resolution multiplied by the magnification factor. The magnification factor may depend on the distances between the light source, the sensor, and the cover-layer interface or sensing/input surface. U.S. patent application Ser. No. 16/006,639, filed Jun. 12, 2018, and titled “Systems And Methods For Optical Sensing Using Point-Based Illumination,” which is hereby incorporated by reference, discusses various issues relating to parameters determining the magnification factor and other useful features pertaining to the various embodiments herein, for example at FIGS. 2, 12A, 12B, and their related description.

The distance between individual LEDs or each cluster of LEDs may depend on the sensitivity and dynamic range of photodetectors (e.g., photosensors such as photodiodes) making up the detector as well as the output power of the source and location of the display and the source with respect to the cover-layer interface. The useful area on the detector is usually determined by the intensity of the source and dynamic range and noise in the detector, because the intensity of the light arriving at the detector follows an inverse relationship with the square of the radius. For a fixed light intensity, the noise of the sensor may determine the maximum imaging radius. This may result in a useful imaging area on the finger that is given by the useful image area on the detector divided by the magnification factor. For a fixed radius of the useful image, if a continuous image of the finger is needed, the light sources could have close distances so the finger images taken using each source overlap or meet.

In certain fingerprint sensing device embodiments, one or more separate LEDs may be used as the light source for illuminating the finger, and the detector (e.g., photodiodes in the display) may be used to measure the reflected light. Typically, photodiodes are placed within areas of the display that are free from circuitry and/or display elements. The reflected light may be measured and used to determine the fingerprint. However, as it is important to illuminate the finger with as much light as possible to provide a more accurate reading of the fingerprint, there is a need to allow more light to pass through the display structure (e.g., from below or within the display) and onto the finger to be reflected back to the detector element(s) on in or below the display.

In display-integrated fingerprint sensing devices, for example, photodiodes are typically uniformly placed within the display area. When the photodiodes are placed on a layer above the light source (e.g., LEDs), some of the photodiodes may block the light emitted by the light source, thereby reducing the amount of light that could illuminate the finger.

In certain embodiments, one or more of these photodiodes are replaced or supplanted with an opening (or hole) in that space instead, so that the amount of light that is provided to the finger for fingerprint sensor may be increased. For example, the amount of light provided to a fingerprint sensing region may be doubled or further increased. Also, as a larger portion of the light is emitted by a small number of defined holes or aperture regions, a larger portion of the light may be provided to one or more well-defined locations. Additionally, in certain embodiments, wherein the photodiodes are disposed in a uniform array, the openings may also be deposed in a uniform manner, maintaining a uniform display for aesthetic purposes.

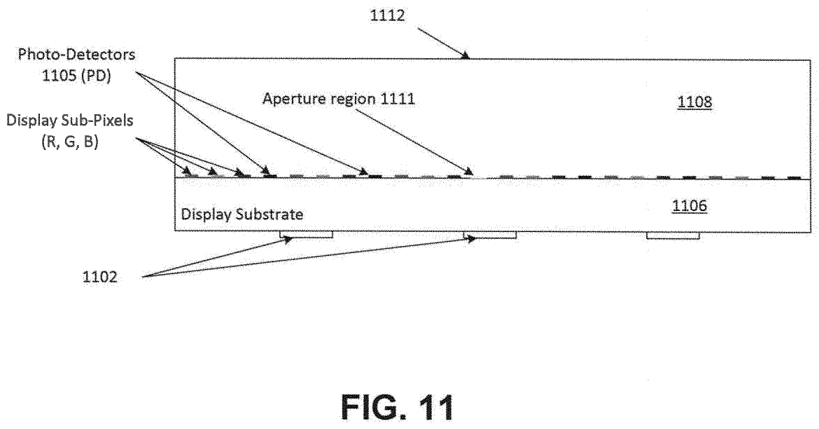

FIG. 11 illustrates a plan view of an optical system 1100 including an aperture region 1111 disposed within the display to facilitate light delivery to a sensing region in the sensing surface 1112 of the optical system, according to an embodiment. Display pixel circuitry, not shown, is provided to drive the display elements responsive to display driver signals and to receive signals from a detector comprised of one or more of the photodetectors 1105. In an embodiment, an aperture region includes a region in a substrate layer or other layer that is devoid of display pixel circuitry (e.g., conductive trace wires or other electronic components) as well as devoid of display elements such as pixels or sub-pixel elements and photodetectors. In the example shown in FIG. 11, aperture region 1111 is located in a position that would otherwise include a photodetector 1105. At least one light source element 1102 is positioned under the display substrate and proximal to aperture region 1111 to enable light from the at least one light source element to illuminate a sensing region in the sensing surface 1112 above more efficiently (i.e., with less or no interference from material or elements in the aperture region). FIG. 11 illustrates an embodiment including a single aperture region 1111, however, it is to be understood that a plurality of aperture regions 1111 may be disposed in the display, either in a regular array or pattern, or in any pattern or arrangement as desired.

FIG. 12 illustrates a top-down view of an optical system 1200 including an aperture region 1211 disposed within the display, according to an embodiment. The optical system 1200 includes a plurality of pixel elements 1201, each composed of sub-pixel elements, e.g., red (R), green (G) and blue (B) light emitting elements. As shown, pixel element 1201 includes an aperture region (AR) 1202 supplanting the photodetector that would otherwise have been located in that position in the regular array of pixels and photodetectors illustrated. Regions E between pixel elements designate areas of the display that could additionally or alternatively include aperture regions, or which could be used to re-position sub-pixel elements or to re-route conductive lines or traces to ensure that aperture region 1202 is devoid of interfering elements, lines or components. For example, during fabrication of various component layers, the patterning or masking may be defined so that such elements, lines or components avoid specified areas designated as aperture regions. In other embodiments, features may be physically removed, e.g., etched.

In certain embodiments, the detector includes one or more photodetectors (e.g., 1105, 1205) disposed within the plurality of pixel elements. In certain embodiments, the detector includes one or more photodetectors (e.g. 1105, 1205) disposed on, within and/or under the same layer that the sub-pixel elements are disposed.

In certain embodiments, where more than one aperture region may be incorporated in a display, the pitch of the aperture regions may be between about 50 μm and about 10 mm, depending on the display resolution and/or the desired application.

For device embodiments incorporating an array of multiple aperture regions and an underlying array of one or more light source elements, the entire display or separate regions of the entire display be used to image objects proximal the sensing surface of the display. For example, all light sources can be illuminated simultaneously, wherein the detector may detects an image of the entire illuminated area. Alternatively, separate light source elements may be activated in a sequence to capture various sub-images of the object(s) being imaged. U.S. patent application Ser. No. 16/006,639, filed Jun. 12, 2018, and titled “Systems And Methods For Optical Sensing Using Point-Based Illumination,” which is hereby incorporated by reference, discusses various useful features pertaining to the various embodiments herein, including for example combination (stitching together) of various images captured as light source elements are illuminated in a sequence to produce a larger image, as well as techniques for correcting or adjusting brightness of individual images of different portions of a finger.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Certain embodiments of this invention are described herein. Variations of those embodiments may become apparent to those of ordinary skill in the art upon reading the foregoing description. The inventors expect skilled artisans to employ such variations as appropriate, and the inventors intend for the embodiments to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An optical sensing system, comprising:
a display substrate;
a plurality of display elements including at least one aperture region in the plurality of display elements;
a sensor light source for illuminating a sensing region, wherein the sensor light source is separate from the plurality of display elements, and wherein the sensor light source is disposed under the display substrate and under the plurality of display elements and is located proximal to the at least one aperture region; and
a detector for detecting light from the sensing region.

2. The optical sensing system of claim 1, wherein the detector comprises one or more photosensors disposed within the plurality of display elements.

3. The optical sensing system of claim 1, wherein the sensor light source comprises one or multiple light emitting diodes (LEDs).

4. The optical sensing system of claim 1, wherein the detector includes a plurality of photosensors disposed on, within or under the display substrate, and wherein the sensor light source is disposed under the detector.

5. The optical sensing system of claim 1, further comprising:
display pixel circuitry for driving the plurality of display elements and disposed over or within the display substrate; and
a transparent cover sheet disposed over the display pixel circuitry, wherein a top surface of the transparent cover sheet provides a sensing surface in the sensing region for sensing an object.

6. The optical sensing system of claim 5, wherein the detector comprises a detector array having a plurality of photosensors for detecting returned light from an active area of the sensing surface, wherein the returned light corresponds to interaction of the emitted light with an object, wherein the plurality of photosensors are disposed within the areal extent of the active area.

7. The optical sensing system of claim 6, wherein the object comprises a fingerprint.

8. The optical sensing system of claim 1, wherein the plurality of display elements includes a plurality of light emitting elements and wherein the detector includes a plurality of photosensors within the plurality of light emitting elements, wherein the at least one aperture region is disposed in a location of, or supplants, at least one photosensor.

9. The optical sensing system of claim 8, wherein the light emitting elements comprise light emitting diodes (LEDs) and the photosensors comprise photodiodes.

10. The optical sensing system of claim 8, wherein the plurality of display elements are arranged in an array pattern.

11. The optical sensing system of claim 1, wherein the at least one aperture region includes multiple aperture regions, and wherein the multiple aperture regions have a pitch of between about 50 μm and about 10 mm.

12. An optical display device, comprising:
a display substrate;
a plurality of display elements including a plurality of aperture regions disposed in the plurality of display elements;
a sensor light source including a plurality of light emitting elements for illuminating a sensing region, wherein the sensor light source is separate from the plurality of display elements, and wherein the sensor light source is disposed under the display substrate and under the plurality of display elements and wherein the plurality of light emitting elements are located proximal to corresponding aperture regions; and
a detector for detecting light from the sensing region.

13. The optical display device of claim 12, wherein the detector comprises a plurality of photosensors disposed within the plurality of display elements.

14. The optical display device of claim 12, further comprising:
display pixel circuitry for driving the plurality of display elements and disposed over or within the display substrate; and
a transparent cover sheet disposed over the display pixel circuitry, wherein a top surface of the transparent cover sheet provides a sensing surface in the sensing region for sensing an object.

15. The optical display device of claim 14, wherein the object comprises a fingerprint.

16. The optical display device of claim 12, wherein the plurality of display elements includes a plurality of light emitting elements and wherein the detector includes a plurality of photosensors within the plurality of light emitting elements, wherein each of the plurality of aperture regions is disposed in a location of, or supplants, one of the plurality of photosensors.

17. The optical display device of claim 16, wherein the light emitting elements comprise light emitting diodes (LEDs) and the photosensors comprise photodiodes.

18. The optical display device of claim 16, wherein the plurality of display elements are arranged in an array pattern.

19. The optical display device of claim 12, wherein the aperture regions have a pitch of between about 50 μm and about 10 mm.
